(19) United States
(12) Patent Application Publication
(10) Pub. No.: US 2016/0298002 A1
(43) Pub. Date: Oct. 13, 2016

(54) ADHESIVE FOR METAL/FABRIC BONDING:PREPARATION AND USING METHOD

(71) Applicants: XIAMEN UNIVERSITY, Xiamen, Fujian (CN); FUJIAN LONGXI BEARING (GROUP) CORP., LTD., Zhangzhou, Fujian (CN)

(72) Inventors: LIZONG DAI, XIAMEN (CN); JIE MAO, XIAMEN (CN); FANPEL ZHENG, XIAMEN (CN); LINGNAN CHEN, XIAMEN (CN); ZHIXIONG CHEN, XIAMEN (CN); BIRONG ZHENG, XIAMEN (CN); LIANGJIA ME, XIAMEN (CN); YITING XU, XIAMEN (CN); WEI'ANG LUO, XIAMEN (CN); XIASHENG XU, XIAMEN (CN); ZHAOCHANG WANG, XIAMEN (CN)

(73) Assignees: XIAMEN UNIVERSITY, XIAMEN, FUJIAN PROVINCE (CN); Fujian Longxi Bearing (Group) Corp., Ltd., Zhangzhou City, Fujian Province (CN)

(21) Appl. No.: 15/034,873

(22) PCT Filed: Nov. 5, 2014
(86) PCT No.: PCT/CN2014/090367

§ 371 Date: May 6, 2016

(30) Foreign Application Priority Data
Nov. 6, 2013 (CN) 201310547144.4

(51) Int. Cl. C09J 11/04; B32B 37/06; C09J 5/02; B32B 37/12; C09J 163/00; C09J 11/06

(52) U.S. Cl. CPC C09J 11/04; C09J 163/00; C09J 11/06; C09J 5/02; B32B 37/12; B32B 37/06; C08K 3/22

(57) ABSTRACT

A new approach for preparation and use of adhesive for metal and fabric bonding is proposed in this invention. Generally, 80-120 g of epoxy resin, 10-30 g of reactive diluent, 0.5-5 g siliane coupling agent, 0.5-5 g metallic oxide nanopowder and 35-60 g curing agent are applied in the formula. With the treatment of silane coupling agent and the mixture of phosphoric acid and nitric acid respectively, the active groups are introduced onto the surface of the metal and the fabric, which enhanced the adhesive strength of metal/fabric interface. Simultaneously, the brittleness, poor cracking and impact resistance of the traditional epoxy adhesive are also optimized by using the method of this invention, which is easy to operate and widely used.

### FIELD OF THE INVENTION

The present invention relates to adhesive, especially to adhesive using for bonding fabric and metal.

### BACKGROUND OF THE INVENTION

Metal agglutination is a novel technology about metal-metal interfacial bonding and metal-nonmetal interfacial bonding, wherein two materials are bonded strongly via the adhesive force of adhesive disposed on solid surface. There are two types of bonding; one is non-structural type which mainly refers to surface coating, sealing and functional bonding, and typical non-structural adhesive includes surface coating adhesive, sealing adhesive and conductive adhesive; another one is structural type which structural units are fixed together via adhesive, the structural adhesive of which as well as bonding point should be capable of transferring stress and do not affect structural integrity or environment applicability within the scope of its design.

Recent years, function materials composed by metal and nonmetal take a more and more important role in the fields of space flight and war industry. However, adhesive is difficult to form stable binding layer with metal and nonmetal due to their different properties, which affects the bonding intensity of composite material. The application of metal agglutination is limited by low peel strength, poor impact strength and short fatigue-resistant time, and therefore it is important to find a simple and practicable method for metal and nonmetal bonding.

Chinese patent No. CN 1074469A discloses a adhesive of enhance modified SBR using for bonding crude rubber and aluminium with a impact strength up to 2.98 kN/m, which is better than normal phenolic resin modified duprene adhesive, however, the process is complicated. Chinese patent No. CN 1273261A discloses a metal/nonmetal adhesive adding chlorosulfonated polyethylene with low preparation cost, however, the process is complicated and the adhesive is of poor heat resistance and poor ageing-resistant. Chinese patent No. CN 1273261A discloses an organic active gel and a method for weldbonding nonmetal and metal, wherein the interface of metal and nonmetal is welded by brazing filler metal with organic gel as transition layer to overcome welding difficulty of nonmetal. However, the welding process is implemented under high-temperature on vacuum oven, which is energy-intensive and complicated.

### SUMMARY OF THE INVENTION

The objective of present invention is to provide epoxy adhesive for metal/fabric bonding with high fatigue-resistant intensity and uniform stress bearing, which overcomes the bonding difficulty of traditional fabric/metal substrate and the shortcomings of ordinary epoxy resin such as hard and brittle, poor cracking resistance and low impact resistance, thereby having application value to metal/nonmetal bonding, especially to metal substrate/fabric strip of self lubricating joint bearing.

The present invention provides adhesive for metal/fabric bonding and method for preparing and using the same.

The metal mainly includes steel, aluminium and its alloys.

The fabric mainly includes polyamide fiber, polyester fiber, polyvinyl alcohol fiber, polyvinyl alcohol fiber, polyvinyl alcohol fiber and their mixture.

The adhesive consists of: 80 to 120 pbw of epoxy resin, 10 to 30 pbw of reactive diluent, 0.5 to 5 pbw of silane coupling agent, 0.5 to 5 pbw of metallic oxide nanopowder and 35 to 60 pbw of curing agent.

The epoxy resin is commercial containing two or more epoxy groups per molecule, which includes epoxy E-44, E-51, E-55, E4-2, E3-1, E4-6 and E-20.

The reactive diluent includes 1,6-hexanediol diacrylate, hydroxy ethyl-β-methacrylate, cresyl glycidyl ether, castor oil glycidyl ether and ethylene glycol diglycidyl ether.

The formula of the silane coupling agent is Y(CH₂)nSiX₃, wherein n=0˜3; X refers to chlor group, methoxy group, methoxy group, methoxyethoxy group or acetoxyl group, and Y refers to amino-group or epoxy group.

The curing agent is amines or acid anhydrides compatible with epoxy resin, which includes ethanediamine, diethylenetriamine, m-phenylenediamine, phthalic anhydride, pyromellitic dianhydride and methylcyclohexene tetracarboxylic dianhydride.

The metallic oxide nanopowder includes ZnO, Al₂O₃, BaO and Fe₃O₄ with particle size ranges from 20 to 200 nm.

The preparation method comprises the steps of:

dissolving metallic oxide nanopowder, silane coupling agent, curing agent onto reactive diluent in turn and stirring for 0.5 to 1 hour to obtain homogeneous emulsion;

adding epoxy resin into the emulsion in portions during ultrasonic and stirring for 0.5 to 2 hours until homogeneous mixed.

The using method comprises the steps of:

preparing a metal substrate via cleaning by acetone, washing by deionized water, drying, coating the silane coupling agent and standing for 0.5-1 hour;

impregnating the fabric in a mixture solution of phosphoric acid and nitric acid with a volume ratio ranges from 1:9 to 4:6 at 40° C.-60° C. for 0.5-2 hours, wherein the concentration of phosphoric acid ranges from 1 to 3 mol/L, and the concentration of nitric acid ranges from 1 to 3 mol/L;

coating the adhesive on the surface of the metal substrate and covering the fabric on the adhesive for drying and press curing.

Comparing to the existing technology, the present invention has advantages as follows:

1. Functional groups are introduced to the surface of metal and fabric after pretreatment and enter into curing reaction of adhesive, thereby improving the adhesive strength and the peeling strength.

2. Silane coupling agent and metallic oxide nanopowder improve the bondability of metal substrate and adhesive and then improve the mechanical strength of adhesive layer. Further, the inorganic component improves the heat resistance of the material.

3. Reactive diluent reduces the brittleness of epoxy resin and improves the impact resistance of the adhesive layer as well.

### BRIEF DESCRIPTION OF THE DRAWINGS

FIG. 1 to FIG. 4 respectively illustrates peeling strength diagram of embodiment 1 to embodiment 4.

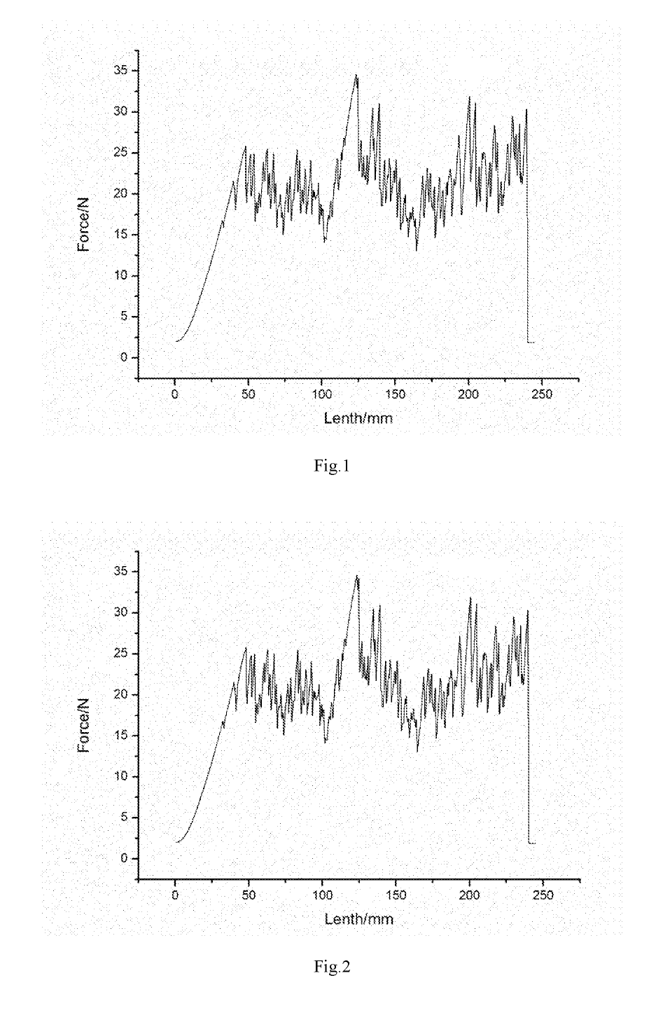

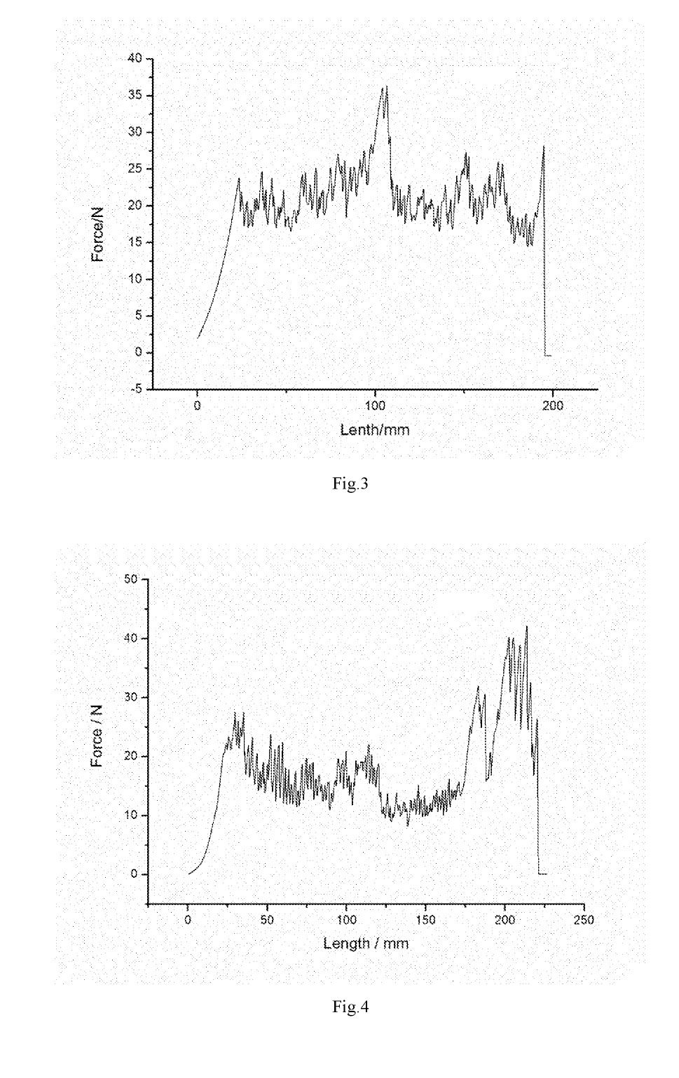

### DETAILED DESCRIPTION OF THE EMBODIMENTS

The present invention will be further described with the drawings and the embodiments.

### Embodiment 1

Aluminium substrate is cleaned by acetone, washed by deionized water and dried in oven for 1 hour to remove impurity such as oxide on the surface, then dipped into silane coupling agent and stand until the surface is dry. Kevlar fabric is washed by absolute alcohol to remove impurity, dried in oven for 1 hour and impregnated in phosphoric acid for 0.5 to 1 hour, then dried.

1 g Al₂O₃ nanopowder, 10 ml ethylene glycol diglycidyl ether, 0.5 g γ-glycidoxy propyl trimethoxy silane, 40 g 4,4-diaminodiphenyl sulfone are dissolved into 35 ml acetone in turn and stirred for 1 hour, then 90 g epoxy resin E51 is added into the emulsion in ten portions during ultrasonic and stirred for 1 hour to obtain adhesive. The adhesive is coated on the surface of prepared aluminium substrate, and the prepared Kevlar fabric is covered on the adhesive. Then the composite is dried in oven at 50° C. for 1 hour, heated to 160° C. in 2 hours to cure for 2 hours under 0.2 MPa pressure. After curing, the peeling strength of the composite is 0.82 N/mm measured by cupping machine.

### Embodiment 2

The pretreatment of metal and fabric refers to embodiment 1.

1 g Al₂O₃ nanopowder, 15 ml ethylene glycol diglycidyl ether, 1 g γ-glycidoxy propyl trimethoxy silane, 50 g 4,4-diaminodiphenyl sulfone are dissolved into 35 ml acetone in turn and stirred for 1 hour, then 100 g epoxy resin E51 is added into the emulsion in ten portions during ultrasonic and stirred for 1 hour to obtain adhesive. The adhesive is coated on the surface of prepared aluminium substrate, and the prepared Kevlar fabric is covered on the adhesive. Then the composite is dried in oven at 50° C. for 1 hour, heated to 160° C. in 2 hours to cure for 2 hours under 0.2 MPa pressure. After curing, the peeling strength of the composite is 1.17 N/mm measured by cupping machine.

### Embodiment 3

The pretreatment of metal and fabric refers to embodiment 1.

0.5 g Al₂O₃ nanopowder, 10 ml ethylene glycol diglycidyl ether, 1 g γ-glycidoxy propyl trimethoxy silane, 60 g 4,4-diaminodiphenyl sulfone are dissolved into 35 ml acetone in turn and stirred for 1 hour, then 120 g epoxy resin E51 is added into the emulsion in ten portions during ultrasonic and stirred for 1 hour to obtain adhesive. The adhesive is coated on the surface of prepared aluminium substrate, and the prepared Kevlar fabric is covered on the adhesive. Then the composite is dried in oven at 50° C. for 1 hour, heated to 160° C. in 2 hours to cure for 2 hours under 0.2 MPa pressure. After curing, the peeling strength of the composite is 1.03 N/mm measured by cupping machine.

### Embodiment 4

The pretreatment of metal and fabric refers to embodiment 1.

1 g Al₂O₃ nanopowder, 20 ml ethylene glycol diglycidyl ether, 0.5 g γ-glycidoxy propyl trimethoxy silane, 55 g 4,4-diaminodiphenyl sulfone are dissolved into 35 ml acetone in turn and stirred for 1 hour, then 100 g epoxy resin E51 is added into the emulsion in ten portions during ultrasonic and stirred for 1 hour to obtain adhesive. The adhesive is coated on the surface of prepared aluminium substrate, and the prepared Kevlar fabric is covered on the adhesive. Then the composite is dried in oven at 50° C. for 1 hour, heated to 160° C. in 2 hours to cure for 2 hours under 0.2 MPa pressure. After curing, the peeling strength of the composite is 1.42 N/mm measured by cupping machine.

### INDUSTRIAL APPLICABILITY

The present invention provides epoxy adhesive for metal/fabric bonding with high fatigue-resistant intensity and uniform stress bearing, which overcomes the bonding difficulty of traditional fabric/metal substrate and the shortcomings of ordinary epoxy resin such as hard and brittle, poor cracking resistance and low impact resistance.

1. An adhesive for metal/fabric bonding of which the metals mainly include steel aluminium and their alloys, while the fabric mainly includes polyamide fiber, polyester fiber, polyvinyl alcohol fiber, polyvinyl alcohol fiber, polyvinyl alcohol fiber and their mixture; the adhesive consists of:
80 g to 120 g of epoxy resin, 10 g to 30 g of a reactive diluent, 0.5 g to 5 g of a silane coupling agent, 0.5 g to 5 g of a metallic oxide nanopowder and 35 g to 60 g of a curing agent;
the method of using the adhesive comprises the steps of:
preparing a metal substrate via cleaning by acetone, washing by deionized water, drying, coating the silane coupling agent and standing for 0.5-1 hour;
impregnating the fabric into a mixture solution of phosphoric acid and nitric acid with a volume ratio ranges from 1:9 to 4:6 at 40° C.-60° C. for 0.5-2 hours, wherein the concentration of phosphoric acid ranges from 1 to 3 mol/L, and the concentration of nitric acid ranges from 1 to 3 mol/L;
coating the adhesive on the surface of the metal substrate and covering the fabric on the adhesive for further drying and press curing.

2. The adhesive for metal/fabric needing according to claim 1, wherein the epoxy resin is commercial containing two or more epoxy groups per molecule, which includes epoxy E-44, E-51, E-55, E4-2, E3-1, E4-6 and E-20.

3. The adhesive for metal/fabric bonding according to claim 2, wherein the reactive diluent includes 1,6-hexanediol diacrylate, hydroxyethyl-β-methacrylate, cresyl glycidyl ether, castor oil glycidyl ether and ethylene glycol diglycidyl ether.

4. The adhesive for metal/fabric bonding according to claim 3, wherein the formula of the silane coupling agent is Y(CH2)nSiX3, wherein n=0˜3; X refers to chloro group, methoxy group, methoxy group, methoxyethoxy group or acetoxyl group, and Y refers to amino-group or epoxy group.

5. The adhesive for metal/fabric bonding according to claim 4, wherein the curing agent is amines or acid anhydrides compatible with epoxy resin, which includes ethanediamine, diethylenetriamine, m-phenylenediamine, phthalic anhydride, pyromellitic dianhydride and methylcyclohexene tetracarboxylic dianhydride.

6. The adhesive for metal/fabric bonding according to claim 5, wherein the metallic oxide nanopowder includes ZnO, Al2O3, BaO and Fe3O4 with particle size ranging from 20 to 200 nm.

7. The adhesive for metal/fabric bonding according to claim 1, wherein the preparation method comprises the steps of:
firstly, dissolving the metallic oxide nanopowder, the silane coupling agent, the curing agent onto the reactive diluent in turn and stirring for 0.5 to 1 hour to obtain homogeneous emulsion;
secondly, adding epoxy resin into the emulsion in batches during ultrasonic and stirring for 0.5 to 2 hours until they are homogeneously mixed.

8. The adhesive for metal/fabric bonding according to claim 2, wherein the preparation method comprises the steps of:
firstly, dissolving the metallic oxide nanopowder, the silane coupling agent, the curing agent onto the reactive diluent in turn and stirring for 0.5 to 1 hour to obtain homogeneous emulsion;
secondly, adding epoxy resin into the emulsion in batches during ultrasonic and stirring for 0.5 to 2 hours until they are homogeneously mixed.

9. The adhesive for metal/fabric bonding according to claim 3, wherein the preparation method comprises the steps of:
firstly, dissolving the metallic oxide nanopowder, the silane coupling agent, the curing agent onto the reactive diluent in turn and stirring for 0.5 to 1 hour to obtain homogeneous emulsion;
secondly, adding epoxy resin into the emulsion in batches during ultrasonic and stirring for 0.5 to 2 hours until they are homogeneously mixed.

10. The adhesive for metal/fabric bonding according to claim 4, wherein the preparation method comprises the steps of:
firstly, dissolving the metallic oxide nanopowder, the silane coupling agent, the curing agent onto the reactive diluent in turn and stirring for 0.5 to 1 hour to obtain homogeneous emulsion;
secondly, adding epoxy resin into the emulsion in batches during ultrasonic and stirring for 0.5 to 2 hours until they are homogeneously mixed.

11. The adhesive for metal/fabric bonding according to claim 5, wherein the preparation method comprises the steps of:
firstly, dissolving the metallic oxide nanopowder, the silane coupling agent the curing agent onto the reactive diluent in turn and stirring for 0.5 to 1 hour to obtain homogeneous emulsion;
secondly, adding epoxy resin into the emulsion in batches during ultrasonic and stirring for 0.5 to 2 hours until they are homogeneously mixed.

12. The adhesive for metal/fabric bonding according in claim 6, wherein; the preparation method comprises the steps of:
firstly, dissolving the metallic oxide nanopowder, the silane coupling agent the curing agent onto the reactive diluent in turn and stirring for 0.5 to 1 hour to obtain homogeneous emulsion;
secondly, adding epoxy resin into the emulsion in hatches during ultrasonic and stirring for 0.5 to 2 hours until they are homogeneously mixed.
